(19) United States
(12) Patent Application Publication
(10) Pub. No.: US 2025/0249785 A1
(43) Pub. Date: Aug. 7, 2025

(54) BATTERY EXCHANGE SYSTEM AND BATTERIES PROVIDING METHOD THEREOF

(71) Applicant: Delta Electronics, Inc., Taoyuan City (TW)

(72) Inventors: CHIN HAO CHEN, Taoyuan City (TW); YU HAO YEH, Taoyuan City (TW); YU AN LI, Taoyuan City (TW)

(73) Assignee: Delta Electronics, Inc., Taoyuan City (TW)

(21) Appl. No.: 18/931,121

(22) Filed: Oct. 30, 2024

Related U.S. Application Data
(60) Provisional application No. 63/550,058, filed on Feb. 6, 2024.

(30) Foreign Application Priority Data
Aug. 12, 2024 (TW) 113130084

(51) Int. Cl. B60L 53/80; B60L 53/65

(52) U.S. Cl. CPC B60L 53/80; B60L 53/65

(57) ABSTRACT

A battery exchange system and a batteries providing method thereof are disclosed. The battery exchange system is configured to perform the method that includes: receiving a request to exchange a target number of batteries; grouping a plurality of batteries in the battery exchange system based on the target number of batteries into a plurality of battery groups; calculating a plurality of scores for the plurality of battery groups based on a plurality of weights and a plurality of characteristic parameters; and selecting an optimal battery group with the optimal score among the plurality of battery groups to provide the target number of batteries based on the plurality of scores. In this way, issues caused by improper battery selection can be effectively improved.

### CROSS REFERENCE TO RELATED APPLICATIONS

This application claims the priority of U.S. Provisional Patent Application No. 63/550,058, titled “BATTERY EXCHANGE SYSTEM AND METHOD FOR PROVIDING BATTERIES POSITIONED THEREIN,” filed on Feb. 6, 2024, and the priority of Taiwan Patent Application No. 113130084, titled “BATTERY EXCHANGE SYSTEM AND BATTERIES PROVIDING METHOD THEREOF,” filed on Aug. 12, 2024, the disclosures of which are incorporated herein by reference.

### FIELD OF THE INVENTION

The present disclosure relates to the technical field of battery management, specifically to a management technology applied to a battery exchange system and a battery-providing method.

### BACKGROUND OF THE INVENTION

Some electric vehicles are powered by replaceable batteries, and users often replace drained batteries with charged ones at battery exchange stations. Battery characteristics will affect the overall system performance of devices or vehicles that use batteries as power sources. For example, current electric vehicles often use multiple batteries to provide power for performance and endurance considerations. Suppose batteries positioned in a battery exchange station are improperly selected. In that case, it will result in negative experiences such as poor energy efficiency, shortened battery life, and inconvenient battery access. It may even cause electric vehicle failure and endanger users.

### SUMMARY OF THE INVENTION

An object of the present disclosure is to provide a battery exchange system and a battery-providing method that effectively improves issues caused by improper battery selection.

To achieve the above object, an aspect of the present disclosure provides a battery exchange system that includes a control part, an electric power part, a sensing part, an interface part, and a plurality of slots, wherein the control part is electrically connected to the electric power part, the sensing part, and the interface part, the interface part is electrically connected to the electric power part, and each of the plurality of slots accommodates one or more batteries; wherein the interface part is configured to receive a request to replace a target number of batteries; the control part is configured to group a plurality of batteries in the battery exchange system into a plurality of battery groups based on the target number of batteries; the control part is configured to calculate a plurality of scores for the plurality of battery groups based on a plurality of weights and a plurality of characteristic parameters; and the control part is configured to cause the processor to select an optimal battery group with the highest score among the plurality of battery groups to provide the target number of batteries based on the plurality of scores.

To achieve the above object, another aspect of the present disclosure provides a method of providing batteries for a battery exchange system, including receiving a request to exchange a target number of batteries; grouping a plurality of batteries in the battery exchange system into a plurality of battery groups based on the target number of batteries; calculating a plurality of scores for the plurality of battery groups based on a plurality of weights and a plurality of characteristic parameters; and selecting an optimal battery group with the highest score among the plurality of battery groups to provide the target number of batteries based on the plurality of scores.

The present disclosure provides the battery exchange system and the method of providing batteries for the battery exchange system, in which the plurality of batteries in the battery exchange system are grouped into the plurality of battery groups based on the target number of batteries, the plurality of scores for the plurality of battery groups is calculated based on the plurality of weights and the plurality of characteristic parameters, and the optimal battery group with the highest score is selected among the plurality of battery groups based on the plurality of scores to provide the target number of batteries. In this way, many battery conditions can be comprehensively considered to select a suitable battery group to provide the target number of batteries. Compared with selecting different batteries sequentially, providing batteries based on the selected battery group can effectively improve the poor user experience and negative impacts on batteries, such as low efficiency in energy, shortened battery life, and inconvenient battery access.

### BRIEF DESCRIPTION OF THE DRAWINGS

FIG. 1 is a schematic diagram illustrating the appearance of an embodiment of a battery exchange system provided in the present disclosure.

FIG. 2 is a systematic block diagram illustrating an embodiment of a battery exchange system provided in the present disclosure.

FIG. 3 is a schematic diagram illustrating an embodiment of battery groups provided in the present disclosure.

FIG. 4 is a schematic diagram illustrating an embodiment of sorting battery groups provided in the present disclosure.

FIG. 5 is a schematic diagram illustrating an embodiment of selecting batteries based on different characteristic parameters provided in the present disclosure.

FIG. 6 is a schematic diagram illustrating another embodiment of selecting batteries based on different characteristic parameters provided in the present disclosure.

FIG. 7 is a schematic diagram illustrating yet another embodiment of selecting batteries based on different characteristic parameters provided in the present disclosure.

FIG. 8 is a flowchart illustrating an embodiment of a method of providing batteries for a battery exchange system provided in the present disclosure.

### THE DETAILED DESCRIPTION OF PREFERRED EMBODIMENTS

To make the above and other objects, characteristics, and advantages of the present disclosure more obvious and easier to understand, preferred embodiments of the present disclosure will be provided, along with the accompanying drawings, in a detailed explanation as follows.

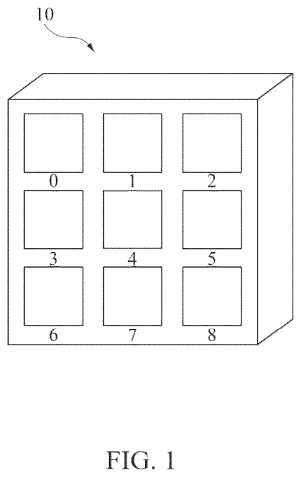

FIG. 1 shows a battery exchange system 10, which is applied to provide batteries for electric vehicles, household appliances, industrial equipment, etc. For example, as shown in FIG. 1, the battery exchange system 10 includes nine exchange slots (indexed from 0 to 8) with batteries.

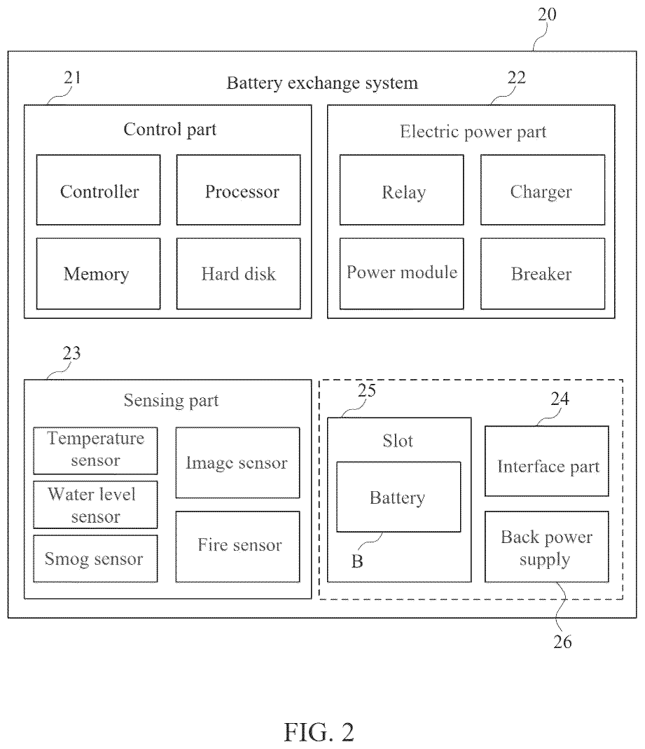

In an embodiment, as shown in FIG. 2, the battery exchange system 20 includes a control part 21, an electric power part 22, a sensing part 23, an interface part 24, a plurality of slots 25, and a backup power supply 26. The control part 21 is electrically connected to the electric power part 22, the sensing part 23, the interface part 24, the slots 25, and the backup power supply 26. The electric power part 22 is electrically connected to the sensing part 23, the interface part 24, the slots 25 and/or the backup power supply 26. Each slot 25 can be used to accommodate one or a plurality of batteries B. The slot 25 can also include a component with an adsorption or blocking function to control the slots 25 to lock the batteries B or release the batteries B according to signals sent by the control part 21.

In an embodiment, as shown in FIG. 2, the control part 21 includes a controller, a processor, a memory, and a hard disk. The controller, the processor, the memory, and the hard disk can perform collaborative operations to execute operations required for a battery exchange process according to predetermined logic or programs. For example, the processor electrically connects the controller, the memory, and the hard disk; the controller is used to control the electronic components in the electric power part 22, the sensing part 23, and the interface part 24; the hard disk is used to store program codes and/or related data; the memory is used to store dynamic data and/or static data. The processor of the control part 21 executes instructions to perform method embodiments of the present disclosure. In another embodiment, appropriate components may be used in the battery exchange system 20 to implement the required functions based on different design considerations. For example, an application-specific integrated circuit (ASIC) with a built-in logic circuit (such as a state machine) that executes functions corresponding to the above instructions is utilized to perform the method embodiments of the present disclosure.

In an embodiment, as shown in FIG. 2, the electric power part 22 includes a relay, a charger, a power module, a circuit breaker, etc. The relay, the charger, the power module, and the circuit breaker are electrically connected appropriately to convert the AC power provided by a commercial power company into DC power or provide the DC power to the batteries B. For example, the electric power part 22 is electrically connected to the control part 21, and the interface part 24. In addition, the control part 21 is configured to control the electric power part 22 to charge at least one of the plurality of batteries B in the slots 25.

The sensing part 23 is used to sense at least one physical quantity. For example, the sensing part 23 includes one or more sensors to sense information such as temperature, water level, image, smoke, and fire. In addition, the measured information can be transmitted to the control part 21 in a wired and/or wireless manner. The control part 21 can perform corresponding control processes or provide battery-related information based on different information. For example, a temperature sensor can be used to detect battery temperature information. The control part 21 determines whether an individual battery can be used based on the battery temperature information to prevent the user from getting an overheated battery due to charging or malfunction. The water level sensor is used to provide water level sensing data for the control part 21 to determine whether the location of the equipment is in a flooded state. The image sensor is used to sense images around the equipment or during use for safety monitoring by the control part 21. The smoke sensor is used to provide smoke sensing data for the control part 21 to determine whether the environment where the equipment is located is in a state of fire and smoke. The fire sensor is used to provide fire sensing data for the control part 21 to determine whether the environment where the equipment is located is in a fire state.

The interface part 24 is electrically connected to the control part 21 and the electric power part 22. The interface part 24 may include components, such as a touch screen, a keyboard, an audio-visual input/output device, and a sound-and-light indicating device to receive or transmit the user's requirements for the battery exchange process. For example, the touch screen with an interactive interface can display battery information and allow users to click on different options. The sound-and-light indicating device can assist the user in replacing the battery. An audio-and-video input device can be used to receive the user's instructions. An audio-and-video output device can be used to provide system-related information to users. During a power outage, the backup power supply 26 can pre-store power to provide DC power to the battery exchange system 20 and/or batteries B.

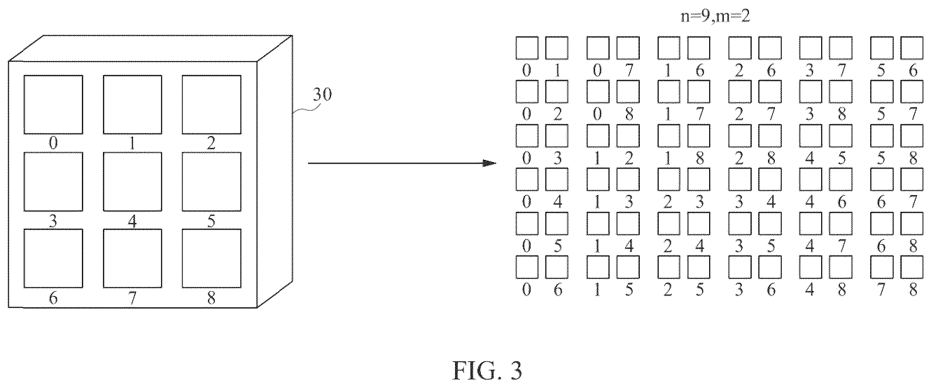

The battery exchange system 30 is in an embodiment shown in FIG. 3 has nine slots. In this embodiment, a user of an electric vehicle user needs to replace two batteries from the battery exchange system 30. The battery exchange system 30 can provide all or part of battery groups, wherein n is the total number of batteries in the battery exchange system 30, and m is a target number required for battery replacement. For example, if all nine slots of the battery exchange system 30 have batteries, then n equals 9, and the number of batteries to be replaced, m, equals 2. Then, the combination of battery groups that the battery exchange system 30 may provide can be expressed as 36 sets of dual battery-group indexes: (0,1), (0,2), (0,3), (0,4), (0,5), (0,6), (0,7), (0,8), (1,2), (1,3), (1,4), (1,5), (1,6), (1,7), (1,8), (2,3), (2,4), (2,5), (2,6), (2,7), (2,8), (3,4), (3,5), (3, 6), (3,7), (3,8), (4,5), (4,6), (4,7), (4,8), (5,6), (5,7), (5,8), (6, 7), (6,8), and (7,8).

As shown in FIG. 3, the battery exchange system 30 can also sort all available battery groups according to battery characteristic parameters and weights to select the best candidate group. The battery exchange system 30 can select three battery characteristic parameters from “battery status,” “battery type,” “battery location,” “power level (status of charge),” and “battery health” as a basis for comparison. In addition, each battery characteristic parameter may be a value, a code, or a data format derived from them associated with a weight. In this embodiment, the battery status indicates whether the batteries within the battery group are available for replacement. The battery type indicates whether the batteries within the battery group include the same battery type (e.g., version). The battery position is a value indicating the distance between multiple batteries within the battery group. For example, coordinate indexes of the batteries within the group are calculated to determine whether the distance between the batteries within the group is relatively short. The power level indicates the state of charge of the batteries within the battery group. For example, a difference or average value of the state of charge of the batteries within the battery group is relatively high or relatively low. The battery health is a value indicating the health status of the batteries within the battery group. For example, two parameters (such as percentages) of the health status of the batteries within the battery group are calculated to determine whether the health status of the batteries within the battery group is good.

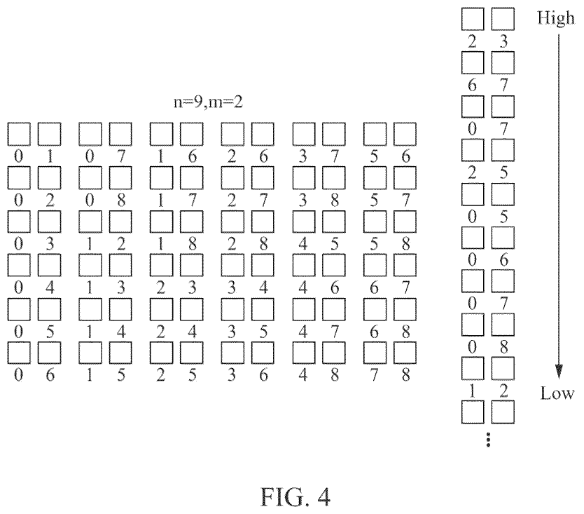

In the example shown in FIG. 3, the battery exchange system 30 can sort thirty-six battery groups according to the above-mentioned characteristic parameters and related weights. FIG. 4 shows an example of sorting. The battery exchange system 30 generates a sorting result, from high to low, listed as (2,3), (6,7), (0,7), (2,5), (0,5), (0,6), (0,7), (0,8), (1,2), among which the best-ranked battery group is (2,3). The battery exchange system 30 can display on the interface part 24 that the battery group (2,3) is a user-replaceable battery group.

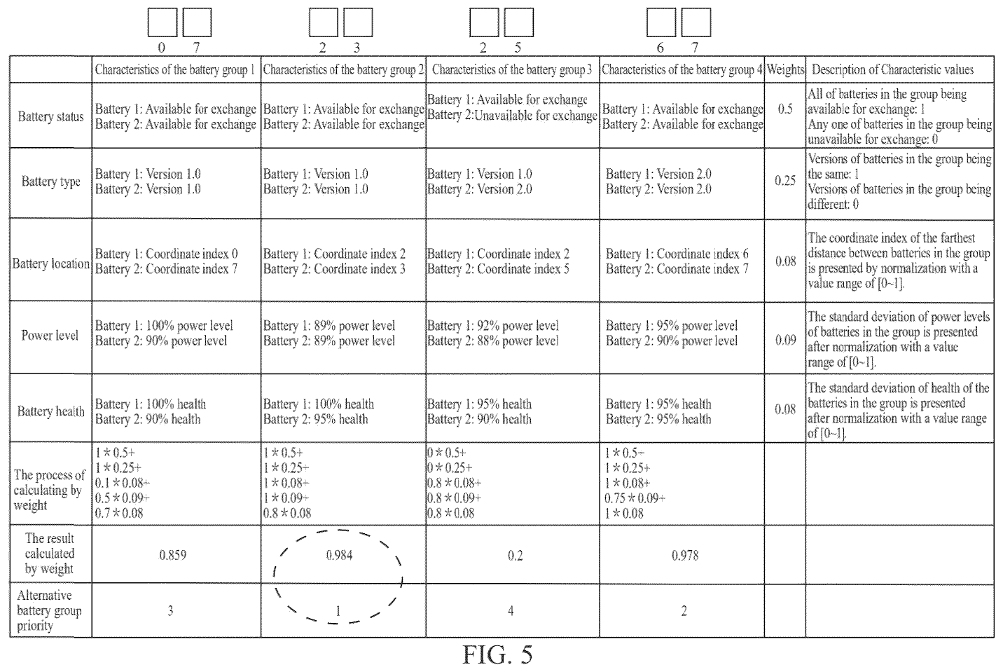

In an embodiment, as shown in FIG. 5, referring to FIGS. 2 and 3, the battery exchange system 30 includes nine slots 25, and the battery exchange system 30 uses components such as the sensing part 23 to measure the batteries B in the slots 25 to obtain the characteristic parameters of the batteries, the control part 21 uses the five characteristic parameters to select an optimal battery group (e.g., including two batteries) from the four battery groups. In this embodiment, weights associated with the five characteristic parameters “battery status,” “battery type,” “battery position,” “power level,” and “battery health” are respectively set to 0.5, 0.25, 0.08, 0.09, and 0.08, wherein the sum in the weights is 1. In the first battery group, a battery-group index is (0,7), and values of the five characteristic parameters, such as the battery status, the battery type, the battery position (the distance between the batteries in the battery exchange system), the power level, and the battery health, are 1, 1, 0.1, 0.5, and 0.7, respectively. In the second battery group, the battery-group index is (2,3), and values of the five characteristic parameters, such as the battery status, the battery type, the battery location, the power level, and the battery health, are 1, 1, 1, 1, and 0.8, respectively. In the third battery group, the battery-group index is (2,5), and values of the five characteristic parameters, such as battery status, battery type, battery location, power, power level, and battery health, are 0, 0, 0.8, 0.8, and 0.8, respectively. In the fourth battery group, the battery-group index is (6,7), and values of the five characteristic parameters, such as battery status, battery type, battery location, power level, and battery health, are 1, 1, 1, 0.75, and 1, respectively. The control part 21 adds products of the characteristic parameters of the four battery groups and the relevant weights to generate four scores according to calculation results. For example, the calculation results are rounded to the third decimal place as the score, e.g., the score of the first battery group's characteristic parameters is 0.859, the score of the second battery group's characteristic parameters is 0.984, the score of the third battery group's characteristic parameters is 0.2, and the score of the fourth battery group's characteristic parameters is 0.978. The control part 21 sorts the four scores from high to low. For example, a sorting result is listed as the score of the second characteristic parameters is 0.984, the score of the fourth characteristic parameters is 0.978, the score of the first characteristic parameters is 0.859, and the score of the third characteristic parameters is 0.984. The score of the group characteristic parameters is 0.2. Because the second characteristic parameters has the highest score, the second battery group is determined to be the best-scored battery group in this example. In another embodiment, the battery exchange system 30 may use an appropriate algorithm to directly select the battery group with the optimal score (such as the bubble sorting method) without the need to sort the battery groups. In other embodiments, the battery exchange system 30 may also use other suitable algorithms to select battery groups. For example, the battery exchange system 30 may select one or more battery groups higher than a preset score.

In some embodiments, the target number required for battery exchange is equal to two (it can also be a plural number of more than two, and “two” is merely taken as an example). The control part 21 calculates the score for each battery group based on five weights as follows:

$${S}_{N} = {A}_{N} * W {1}_{N} + {B}_{N} * W {2}_{N} + {C}_{N} * W {3}_{N} + {D}_{N} * W {4}_{N} + {E}_{N} * W {5}_{N} ;$$

In the above equation, S_{N} is the score of the Nth battery group among the plurality of battery groups, and N is a positive integer; A_{N} is a battery status parameter of the Nth battery group, which indicates whether a plurality of batteries within the Nth battery group can be replaced; B_{N} is a battery type parameter of the Nth battery group, which indicates whether the plurality of batteries within the Nth battery group have the same battery type; C_{N} is a power level parameter of the Nth battery group, which indicates a difference in state-of-charge of the plurality of batteries within the Nth battery group; D_{N} is a battery health parameter of the Nth battery group, which indicates a difference in battery health of the plurality of batteries in the Nth battery group; E_{N} is a battery position parameter of the Nth battery group, which indicates a spacing of the plurality of batteries within the Nth battery group. In one embodiment, W1_{N} is equal to 0.5, W2_{N} is equal to 0.25, W3_{N} is equal to 0.09, W4_{N} is equal to 0.08, and W5_{N} is equal to 0.08. In this way, the batteries are selected based on the characteristic weights associated with availability status, version type, relative position, power level, and health of the batteries. More battery characteristics can be used to select the batteries to improve low efficiency in energy, shortened battery life, and inconvenient battery access. Thus, the poor user experience and negative impacts on batteries can be effectively improved.

In an embodiment, if there are two or more battery groups with the same highest score, the battery exchange system 30 may randomly select one of a plurality of groups with the highest score to provide to a user.

The battery exchange system 30 may also use other suitable algorithms to select the battery groups with the same score. In another embodiment, if there are two or more battery groups with the same highest score, the battery exchange system 30 can perform a comparison of battery characteristic parameters such as “power level,” “battery health,” and “battery location” sequentially until only one battery group can be determined as the optimal battery group. For example, the control part 21 of the battery exchange system 30 first calculates a sum in power level of the batteries within the battery group (e.g., expressed as a percentage) among two or more battery groups with the same score. The battery group with the maximum sum in power level among two or more battery groups with the same score is regarded as the optimal battery group. Suppose there are still two or more battery groups whose sums in power level are equal. In that case, the control part 21 further calculates a sum in battery health (e.g., expressed in a percentage) of the two or more battery groups whose sums in power level are equal. Then, the optimal battery group is the battery group with the maximum sum in power level. If there are still two or more battery groups with equal sums in battery health, the control part 21 further calculates a difference in coordinate index for battery positions of the two or more battery groups with equal sums in health to determine that the optimal battery group is the battery group with the smallest difference in the coordinate index of the battery positions (i.e., the shortest total distance) among the two or more battery groups with equal sums in battery health. In another embodiment, the order of comparing battery characteristic parameters, such as power level, battery health, and battery location, can be changed according to different design considerations.

In some embodiments, the control part 21 of the battery exchange system is further configured to cause the processor to execute one or more instructions to perform one or more operations, the operations including: in response to determining two or more battery groups with the same highest score among the plurality of battery groups, selecting one battery group with the highest sum of ratings in state-of-charge of batteries among the battery groups with the same highest score to provide the target number of batteries; in response to determining two or more battery groups with the same highest sum of ratings in state-of-charge among the plurality of battery groups, selecting one battery group with the highest sum of ratings in battery health of batteries among the battery groups with the same highest rating in state-of-charge to provide the target number of batteries; and in response to determining two or more battery groups with the same highest sum of ratings in battery health among the plurality of battery groups, selecting a battery group with the shortest total spacing of batteries among the battery groups with the same highest rating in battery health to provide the target number of batteries. In this way, in the case that the scores are the same, compared to the random selection method, a more suitable battery group can be selected sequentially based on conditions such as state of charge, health degree, and spacing.

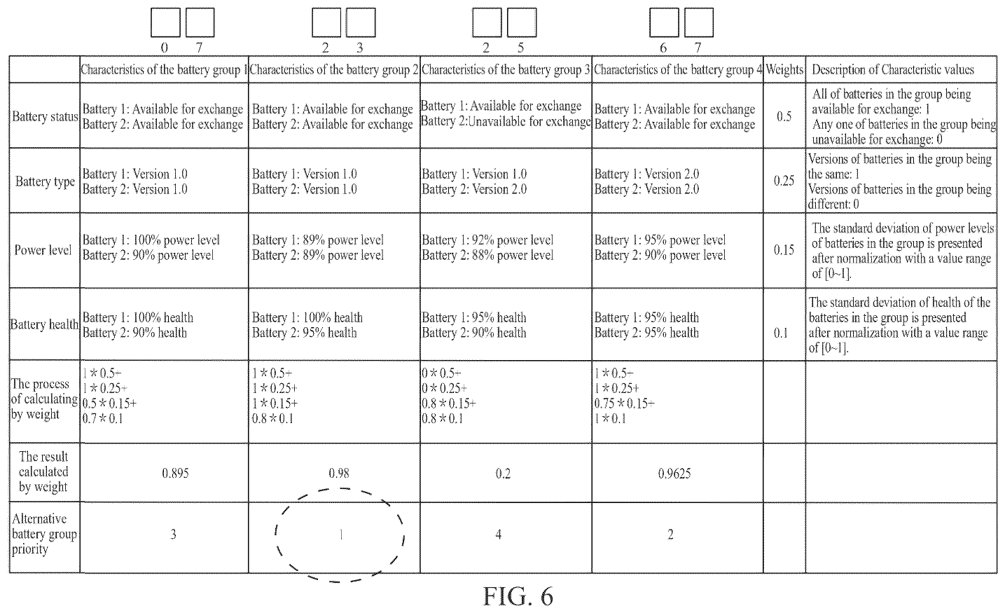

As shown in the embodiment shown in FIG. 6, referring to FIGS. 2 and 3, the battery exchange system 30 includes nine slots, and the battery exchange system 30 uses components such as the sensing part 23 to measure the batteries B in the slots 25 to obtain the characteristic parameters of the batteries. In this embodiment, the control part 21 selects two batteries from the four battery groups using the four characteristic parameters. In this embodiment, the weights associated with the four characteristic parameters, “battery status,” “battery type,” “power level,” and “battery health,” are set to 0.5, 0.25, 0.15, and 0.1, respectively. The sum in the weights is 1. In the first battery group, the battery-group index is (0,7), and values of the four characteristic parameters (i.e., the battery status, the battery type, the power level, and the battery health) are 1, 1, 0.5, and 0.7, respectively. In the second battery group, the battery-group index is (2,3), and values of the four characteristic parameters (i.e., the battery status, the battery type, the power level, and the battery health) are 1, 1, 1, and 0.8, respectively. In the third battery group, the battery-group index is (2,5), and values of the four characteristic parameters (i.e., the battery status, the battery type, the power level, and the battery health) are 0, 0, 0.8, and 0.8, respectively. In the fourth battery group, the battery-group index is (6,7), and values of the four characteristic parameters (i.e., the battery status, the battery type, the power level, and the battery health) are 1, 1, 0.75, and 1, respectively. Then, the control part 21 adds the products of characteristic parameters and the relevant weights of the four battery groups to generate four scores for the four battery groups according to calculation results. For example, the score of the first battery group's characteristic parameters is 0.895, the score of the battery group's second group of characteristics is 0.98, the score of the third battery group's characteristic parameters is 0.2, and the score of the fourth battery group's characteristic parameters is 0.9625. Then, the control part 21 further sorts the four scores from high to low. For example, a sorting result is listed as the score of the second battery group's characteristic parameters is 0.98, the score of the fourth battery group's characteristic parameters is 0.9625, the score of the first battery group's characteristic parameters is 0.895, and the score of the third battery group's characteristic parameters is 0.2. Thus, the control part 21 selects the second battery group with the highest score as an optimal-scored battery group in this example. In another embodiment, the battery exchange system may also select the battery group with the optimal score as the optimal battery group and provide it to the user without the need for a sorting process.

In some embodiments, the target number of battery exchange requirements is equal to two (it can also be a plural number of more than two, and “two” is merely taken as an example), and the control part 21 calculates a score of each of the plurality of battery groups according to four weights, as follows:

$${S}_{N} = {A}_{N} * W {1}_{N} + {B}_{N} * W {2}_{N} + {C}_{N} * W {3}_{N} + {D}_{N} * W {4}_{N} ;$$

In the above equation, S_{N} is the score of the Nth battery group among the plurality of battery groups, and N is a positive integer; A_{N} is a battery status parameter of the Nth battery group, which indicates whether a plurality of batteries within the Nth battery group can be replaced; B_{N} is a battery type parameter of the Nth battery group, which indicates whether the plurality of batteries within the Nth battery group have the same battery type; C_{N} is a power level parameter of the Nth battery group, which indicates a difference in state-of-charge of the plurality of batteries within the Nth battery group; D_{N} is a battery health parameter of the Nth battery group, which indicates a difference in battery health of the plurality of batteries in the Nth battery group. In one embodiment, WIN is equal to 0.5, W2_{N} is equal to 0.25, W3_{N} is equal to 0.15, and W4_{N} is equal to 0.1. In this way, the batteries are selected based on the characteristic weights associated with availability status, version type, power level, and health of the batteries. More battery characteristics can be used to select the batteries to improve low efficiency in energy, shortened battery life, and inconvenient battery access. Thus, the poor user experience and negative impacts on batteries can be effectively improved.

As shown in FIG. 6, if there is a situation where the highest ratings in two or more battery groups are the same, the battery exchange system can randomly select the battery group with the optimal score. In the embodiments mentioned above, the control part 21 uses a higher score as the optimal score. In other embodiments, the control part 21 can also use a lower score or a score closer to a target value to be the optimal score.

The battery exchange system can perform another sorting process that sequentially compares “power level” and “battery health” until only one battery group is determined to be the optimal battery group. For example, the sum in the power level of two batteries (e.g., expressed as a percentage) for two or more battery groups is first calculated to determine that the battery group with the maximum sum in power level among the two or more battery groups is the optimal battery group. If the sums in the power level of the two batteries in the two or more battery groups are equal, then the sum(s) in the battery health (e.g., expressed as a percentage) of two batteries within one or more battery groups within the two or more battery groups is further calculated to determine that the optimal battery group(s) is/are one or more battery group with the maximum sum in the battery health of the two batteries among the two or more battery groups. In another embodiment, the order of comparing characteristic parameters such as power level and battery health can be changed according to different design considerations.

In some embodiments, the control part 21 of the battery exchange system is further configured to cause the processor to execute one or more instructions to perform one or more operations, the operations including: in response to determining two or more battery groups with the same highest score among the plurality of battery groups, selecting one battery group with the highest sum of ratings in state-of-charge of batteries among the battery groups with the same highest score to provide the target number of batteries; and in response to determining two or more battery groups with the same highest sum of ratings in state-of-charge among the plurality of battery groups, selecting one battery group with the highest sum of ratings in battery health of batteries among the battery groups with the same highest rating in state-of-charge to provide the target number of batteries. In this way, in the case that the scores are the same, compared to the random selection method, a more suitable battery group can be selected sequentially based on conditions such as state of charge and health degree.

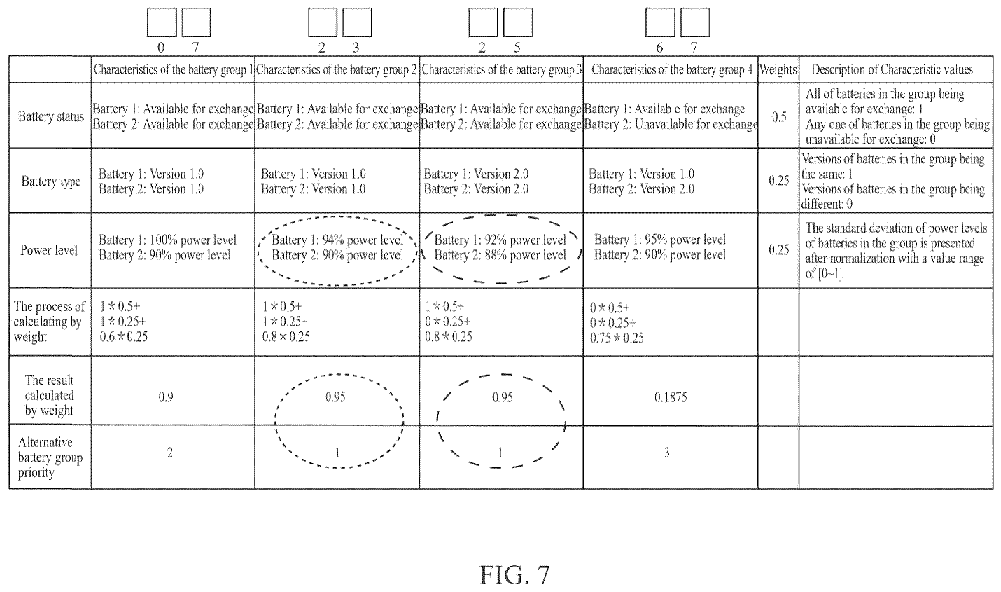

As shown in the embodiment shown in FIG. 7, referring to FIGS. 2 and 3, the battery exchange system 30 includes a battery exchange system with nine slots 25, and three characteristic parameters are used to select two batteries from four battery groups. In this embodiment, the weights associated with the three characteristic parameters, “battery status,” “battery type,” and “power level,” are predetermined to be 0.5, 0.25, and 0.25, respectively, and the sum in the weights is 1. In the first battery group, the battery-group index is (0,7), and values of the three characteristic parameters, such as the battery status, the battery type, and the power level, are 1, 1, and 0.6, respectively. In the second battery group, the battery-group index is (2,3), and values of the three characteristic parameters, such as the battery status, the battery type, and the power level, are 1, 1, and 0.8, respectively. In the third battery group, the battery-group index is (2,5), and values of the three characteristic parameters, such as the battery status, the battery type, and the power level, are 1, 0, and 0.8, respectively. In the fourth battery group, the battery-group index is (6,7), and values of the three characteristic parameters, such as the battery status, the battery type, and the power level, are 0, 0, and 0.75, respectively. Then, products of the four battery groups' characteristic parameters and the relevant weights can be added to generate four scores based on calculation results. For example, the score of the first battery group's characteristic parameters is 0.9, the score of the second battery group's characteristic parameters is 0.95, the score of the third battery group's characteristic parameters is 0.95, and the score of the fourth battery group's characteristic parameters is 0.1875. Then, the four scores are further sorted from high to low. For example, a sorting result is listed as the score of the second battery group's characteristic parameter is 0.95, the score of the third battery group's characteristic parameter is 0.95, the score of the first battery group's characteristic parameter is 0.9, and the score of the fourth battery group's characteristic parameter is 0.1875. Finally, because the second and third battery group's characteristic parameters have the highest scores, one of the second and third battery groups is determined to be the battery group with the optimal rating in this example. In another embodiment, the battery exchange system may select the battery group with the optimal score as the optimal battery group and provide it to the user.

In some embodiments, the target number of battery exchange requirements is equal to two (it can also be a plural number of more than two, and “two” is merely taken as an example), and the control part 21 calculates a value of each of the plurality of battery groups according to three weights, as follows:

$${S}_{N} = {A}_{N} * W {1}_{N} + {B}_{N} * W {2}_{N} + {C}_{N} * W {3}_{N} ;$$

In the above equation, S_{N} is the score of the Nth battery group among the plurality of battery groups, and N is a positive integer; A_{N} is a battery status parameter of the Nth battery group, which indicates whether a plurality of batteries within the Nth battery group can be replaced; B_{N} is a battery type parameter of the Nth battery group, which indicates whether the plurality of batteries within the Nth battery group have the same battery type; C_{N} is a power level parameter of the Nth battery group, which indicates a difference in state-of-charge of the plurality of batteries within the Nth battery group. In this way, batteries are selected based on the feature weights associated with the battery's availability status, version type, and power level. Thus, fewer battery characteristics are used to select batteries to improve situations such as low energy efficiency, which can effectively improve poor user experience and negative impacts on batteries.

As shown in FIG. 7, the highest scores of the two groups are the same (that is, in this example, the scores of the second and third battery groups are both 0.95). In one embodiment, the battery exchange system can randomly select the second battery group or the third battery group as the battery group with the optimal score.

The battery exchange system may perform another sorting process comparing “power level” until only one of the second and third battery groups is determined to be the optimal battery group. For example, the sum in the power level (for example, expressed in percentage) of the two batteries within the second battery group is 184 (=94+90), which is greater than the sum in the power level of the two batteries within the third battery group which is 180 (=92+88). Finally, the second battery group is determined to be the battery group with the optimal score.

In some embodiments, the control part of the battery exchange system is further configured to cause the processor to execute one or more instructions to perform one or more operations, the operations including: in response to determining two or more battery groups with the same highest score among the plurality of battery groups, selecting one battery group with the highest sum of ratings in state-of-charge of batteries among the battery groups with the same highest score to provide the target number of batteries. In this way, when the scores are the same, a more suitable battery group can be selected based on the state of charge compared to random selection.

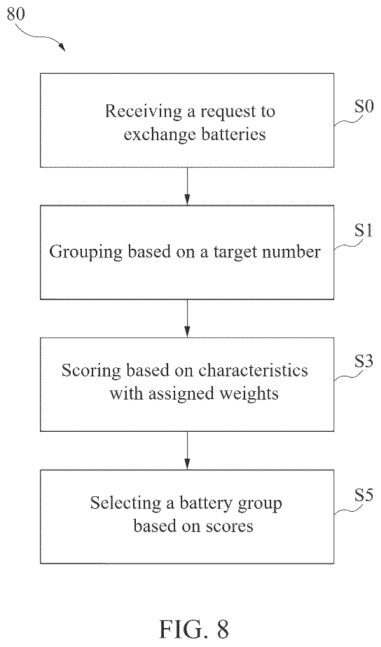

FIG. 8 shows an embodiment of a battery-providing method 80 of the battery exchange system 30. Referring to FIGS. 2 and 3, the battery-providing method 80 includes: in step S0, the battery exchange system 30 receives a request to exchange batteries through the interface part 24, wherein the target number of exchange requirements may be a system preset value or a target number (e.g., at least two) input by the user and received by the interface part 24. In step S1, the control part 21 groups the batteries B in the slot 25 according to the target number, for example, into m combinations of battery groups according to all or part of the batteries number n in the slot 25 and the target number m, wherein each combination includes the target number of batteries. In step S3, the control part 21 scores the battery groups according to battery characteristic parameters and corresponding weights. For example, the score of each combination is calculated based on the battery characteristic parameters and related weights. In step S5, a battery group is selected based on a scoring result. For example, the control part 21 selects a battery group with the optimal score from the battery groups based on the scores.

A larger value for the characteristic parameter “battery status” means that all batteries in a battery group can be exchanged; a larger value for the characteristic parameter “battery type” means that all batteries in a battery group are of the same type (version); the characteristic parameter “battery position (distance between batteries)” indicates that the distance between two batteries of a battery group in the battery exchange system is relatively longer or relatively shorter; the larger the characteristic parameter “power level” means, the higher the average power level of a battery group in which the difference (such as standard deviation) in the power level between batteries is relatively small; the larger the characteristic parameters “battery health” means, the battery health in a battery group is relatively high.

A value of the characteristic parameter “battery status” can be determined based on “battery certification,” “battery and slot status,” “battery voltage,” and “battery exchange system status.” For example, “battery certification” is used to indicate whether the battery is a certified battery; “battery and slot status” is used to indicate whether the battery and slot have errors; “battery voltage” is used to indicate whether the battery voltage is greater than a preset threshold; “battery exchange system status” is used to indicate whether the battery exchange system has any errors related to exchange operations.

A value of the characteristic parameter “battery status” can also be determined based on one or more of “battery health,” “battery life,” “battery temperature and time,” and “wrong safety behavior flag.” For example, “battery health” is used to indicate whether the battery health is greater than a preset threshold; “battery life” is used to indicate whether the battery life has expired; “battery temperature and time” is used to indicate whether the battery temperature is between a high-temperature threshold and a low-temperature and whether the return time is longer than the preset threshold; the “error safe behavior flag” is used to indicate whether there is an error flag with a logical value of “TRUE.”

The characteristic parameters may be a binary value (e.g., “0” or “1”) indicating a binary status of all batteries in a battery group, such as exchangeable or type (version). In another example, each characteristic parameter may be a value ranging between 0 and 1 to indicate the degree of a particular characteristic of the two batteries within the battery group, such as a normalization value of a physical distance, a power level difference, or health status. In another example, the characteristic parameter may also be other suitable positive or negative values.

The battery exchange system and its battery exchange method, according to the above embodiments of the present disclosure, are provided to divide the batteries in the battery exchange system into a plurality of battery groups based on the target number and calculate a plurality of scores of a plurality of battery groups based on a plurality of weights and a plurality of characteristic parameters, and select the optimal battery group with the optimal score among the plurality of battery groups to provide the target number of batteries. In this way, many states of the batteries can be comprehensively considered to select a suitable battery group to provide the target number of batteries. Compared with the batteries provided by the battery group, which selects different batteries one after another, it can effectively improve the poor user experience and negative effects on batteries, such as low energy efficiency, shortened battery life, and inconvenient battery access.

What is claimed is:

1. A method of providing batteries for a battery exchange system, comprising:
receiving a request to exchange a target number of batteries;
grouping a plurality of batteries in the battery exchange system into a plurality of battery groups based on the target number of batteries;
calculating a plurality of scores for the plurality of battery groups based on a plurality of weights and a plurality of characteristic parameters; and
selecting an optimal battery group with the highest score among the plurality of battery groups to provide the target number of batteries based on the plurality of scores.

2. The method as claimed in claim 1, wherein the plurality of weights comprise three weights, and the score of each of the plurality of battery groups is calculated as follows:
$${S}_{N} = {A}_{N} * W {1}_{N} + {B}_{N} * W {2}_{N} + {C}_{N} * W {3}_{N} ;$$
wherein S_{N} is the score of the Nth battery group among the plurality of battery groups, and N is a positive integer; A_{N} is a battery status parameter of the Nth battery group, which indicates whether a plurality of batteries within the Nth battery group can be replaced; B_{N} is a battery type parameter of the Nth battery group, which indicates whether the plurality of batteries within the Nth battery group have the same battery type; C_{N} is a power level parameter of the Nth battery group, which indicates a difference in state-of-charge of the plurality of batteries within the Nth battery group.

3. The method as claimed in claim 2, further comprising:
in response to determining two or more battery groups with the same highest score among the plurality of battery groups, selecting one battery group with the highest sum of ratings in state-of-charge of batteries among the battery groups with the same highest score to provide the target number of batteries.

4. The method as claimed in claim 1, wherein the plurality of weights comprise four weights, and the score of each of the plurality of battery groups is calculated as follows:
$${S}_{N} = {A}_{N} * W {1}_{N} + {B}_{N} * W {2}_{N} + {C}_{N} * W {3}_{N} + {D}_{N} * W {4}_{N} ;$$
wherein S_{N} is the score of the Nth battery group among the plurality of battery groups, and N is a positive integer; A_{N} is a battery status parameter of the Nth battery group, which indicates whether a plurality of batteries within the Nth battery group can be replaced; B_{N} is a battery type parameter of the Nth battery group, which indicates whether the plurality of batteries within the Nth battery group have the same battery type; C_{N} is a power level parameter of the Nth battery group, which indicates a difference in state-of-charge of the plurality of batteries within the Nth battery group; D_{N} is a battery health parameter of the Nth battery group, which indicates a difference in battery health of the plurality of batteries in the Nth battery group.

5. The method as claimed in claim 4, further comprising:
in response to determining two or more battery groups with the same highest score among the plurality of battery groups, selecting one battery group with the highest sum of ratings in state-of-charge of batteries among the battery groups with the same highest score to provide the target number of batteries; and
in response to determining two or more battery groups with the same highest sum of ratings in state-of-charge among the plurality of battery groups, selecting one battery group with the highest sum of ratings in battery health of batteries among the battery groups with the same highest rating in state-of-charge to provide the target number of batteries.

6. The method as claimed in claim 1, wherein the plurality of weights comprise five weights, and the score of each of the plurality of battery groups is calculated as follows:
$${S}_{N} = {A}_{N} * W {1}_{N} + {B}_{N} * W {2}_{N} + {C}_{N} * W {3}_{N} + {D}_{N} * W {4}_{N} + {E}_{N} * W {5}_{N} ;$$
wherein S_{N} is the score of the Nth battery group among the plurality of battery groups, and N is a positive integer; A_{N} is a battery status parameter of the Nth battery group, which indicates whether a plurality of batteries within the Nth battery group can be replaced; B_{N} is a battery type parameter of the Nth battery group, which indicates whether the plurality of batteries within the Nth battery group have the same battery type; C_{N} is a power level parameter of the Nth battery group, which indicates a difference in state-of-charge of the plurality of batteries within the Nth battery group; D_{N} is a battery health parameter of the Nth battery group, which indicates a difference in battery health of the plurality of batteries in the Nth battery group; E_{N} is a battery position parameter of the Nth battery group, which indicates a spacing of the plurality of batteries within the Nth battery group.

7. The method as claimed in claim 6, further comprising:
in response to determining two or more battery groups with the same highest score among the plurality of battery groups, selecting one battery group with the highest sum of ratings in state-of-charge of batteries among the battery groups with the same highest score to provide the target number of batteries;
in response to determining two or more battery groups with the same highest sum of ratings in state-of-charge among the plurality of battery groups, selecting one battery group with the highest sum of ratings in battery health of batteries among the battery groups with the same highest rating in state-of-charge to provide the target number of batteries; and
in response to determining two or more battery groups with the same highest sum of ratings in battery health among the plurality of battery groups, selecting a battery group with the shortest total spacing of batteries among the battery groups with the same highest rating in battery health to provide the target number of batteries.

8. A battery exchange system, comprising:
a control part, an electric power part, a sensing part, an interface part, and a plurality of slots, wherein the control part is electrically connected to the electric power part, the sensing part, and the interface part, the interface part is electrically connected to the electric power part, and each of the plurality of slots accommodates one or more batteries; wherein
the interface part is configured to receive a request to replace a target number of batteries;
the control part is configured to group a plurality of batteries in the battery exchange system into a plurality of battery groups based on the target number of batteries;
the control part is configured to calculate a plurality of scores for the plurality of battery groups based on a plurality of weights and a plurality of characteristic parameters; and
the control part is configured to cause the processor to select an optimal battery group with the highest score among the plurality of battery groups to provide the target number of batteries based on the plurality of scores.

9. The battery exchange system as claimed in claim 8, wherein the plurality of weights comprise three weights, and the score of each of the plurality of battery groups is calculated as follows:
$${S}_{N} = {A}_{N} * W {1}_{N} + {B}_{N} * W {2}_{N} + {C}_{N} * W {3}_{N} ;$$
wherein S_{N} is the score of the Nth battery group among the plurality of battery groups, and N is a positive integer; A_{N} is a battery status parameter of the Nth battery group, which indicates whether a plurality of batteries within the Nth battery group can be replaced; B_{N} is a battery type parameter of the Nth battery group, which indicates whether the plurality of batteries within the Nth battery group have the same battery type; C_{N} is a power level parameter of the Nth battery group, which indicates a difference in state-of-charge of the plurality of batteries within the Nth battery group.

10. The battery exchange system as claimed in claim 9, wherein the control part is further configured to cause a processor to execute one or more instructions to perform one or more operations, the operations comprising:
in response to determining two or more battery groups with the same highest score among the plurality of battery groups, selecting one battery group with the highest sum of ratings in state-of-charge of batteries among the battery groups with the same highest score to provide the target number of batteries.

11. The battery exchange system as claimed in claim 8, wherein the plurality of weights comprise four weights, and the score of each of the plurality of battery groups is calculated as follows:
$${S}_{N} = {A}_{N} * W {1}_{N} + {B}_{N} * W {2}_{N} + {C}_{N} * W {3}_{N} + {D}_{N} * W {4}_{N} ;$$
wherein S_{N} is the score of the Nth battery group among the plurality of battery groups, and N is a positive integer; A_{N} is a battery status parameter of the Nth battery group, which indicates whether a plurality of batteries within the Nth battery group can be replaced; B_{N} is a battery type parameter of the Nth battery group, which indicates whether the plurality of batteries within the Nth battery group have the same battery type; C_{N} is a power level parameter of the Nth battery group, which indicates a difference in state-of-charge of the plurality of batteries within the Nth battery group; D_{N} is a battery health parameter of the Nth battery group, which indicates a difference in battery health of the plurality of batteries in the Nth battery group.

12. The battery exchange system as claimed in claim 11, wherein the control part is further configured to cause a processor to execute one or more instructions to perform one or more operations, the operations comprising:
in response to determining two or more battery groups with the same highest score among the plurality of battery groups, selecting one battery group with the highest sum of ratings in state-of-charge of batteries among the battery groups with the same highest score to provide the target number of batteries; and
in response to determining two or more battery groups with the same highest sum of ratings in state-of-charge among the plurality of battery groups, selecting one battery group with the highest sum of ratings in battery health of batteries among the battery groups with the same highest rating in state-of-charge to provide the target number of batteries.

13. The battery exchange system as claimed in claim 8, wherein the plurality of weights comprise five weights, and the score of each of the plurality of battery groups is calculated as follows:
$${S}_{N} = {A}_{N} * W {1}_{N} + {B}_{N} * W {2}_{N} + {C}_{N} * W {3}_{N} + {D}_{N} * W {4}_{N} + {E}_{N} * W {5}_{N} ;$$
wherein S_{N} is the score of the Nth battery group among the plurality of battery groups, and N is a positive integer; A_{N} is a battery status parameter of the Nth battery group, which indicates whether a plurality of batteries within the Nth battery group can be replaced; B_{N} is a battery type parameter of the Nth battery group, which indicates whether the plurality of batteries within the Nth battery group have the same battery type; C_{N} is a power level parameter of the Nth battery group, which indicates a difference in state-of-charge of the plurality of batteries within the Nth battery group; D_{N} is a battery health parameter of the Nth battery group, which indicates a difference in battery health of the plurality of batteries in the Nth battery group; E_{N} is a battery position parameter of the Nth battery group, which indicates a spacing of the plurality of batteries within the Nth battery group.

14. The battery exchange system as claimed in claim 13, wherein the control part is further configured to cause a processor to perform one or more operations, the operations comprising:
in response to determining two or more battery groups with the same highest score among the plurality of battery groups, selecting one battery group with the highest sum of ratings in state-of-charge of batteries among the battery groups with the same highest score to provide the target number of batteries;
in response to determining two or more battery groups with the same highest sum of ratings in state-of-charge among the plurality of battery groups, selecting one battery group with the highest sum of ratings in battery health of batteries among the battery groups with the same highest rating in state-of-charge to provide the target number of batteries; and
in response to determining two or more battery groups with the same highest sum of ratings in battery health among the plurality of battery groups, selecting a battery group with the shortest total spacing of batteries among the battery groups with the same highest rating in battery health to provide the target number of batteries.
